(19) United States
(12) Patent Application Publication
(10) Pub. No.: US 2005/0150741 A1
(43) Pub. Date: Jul. 14, 2005

(54) Coin shape detection method, coin identification sensor, and coin identification device

(75) Inventors: Kazuhiro Yamakawa, Kounosu-shi (JP); Kazuaki Tabata, Kawasaki-shi (JP)

Correspondence Address: OLIFF & BERRIDGE, PLC, P.O. BOX 19928, ALEXANDRIA, VA, 22320, US

(73) Assignee: AZUMA SYSTEMS CO. LTD, SAITAMA (JP)

(21) Appl. No.: 10/512,137

(22) PCT Filed: Apr. 22, 2003
(86) PCT No.: PCT/JP03/05130

(30) Foreign Application Priority Data
Apr. 26, 2002 (JP) 2002-126589

(51) Int. Cl. G07D 5/08

(52) U.S. Cl. 194/320

(57) ABSTRACT

In a coin configuration detection method and a coin identification sensor that magnetically detect the coin configuration, coin configuration detection is enabled to be accurately performed. Moreover, in a coin identification apparatus, the coin identification accuracy is improved. In a coin configuration detection method (coin identification sensor 1) that magnetically detects the configuration of a coin 2 to identify the kind and/or the authenticity of the coin 2, a magnetic flux change in the vicinity of the surface of the coin 2 is detected by a detection coil 7 in which a coil central line is along the surface of the coin 2 and a coil peripheral surface is locally opposed to the surface of the coin 2 while an AC magnetic field along the surface of the coin 2 is generated in the interior of the coin 2 and/or in the surface space of the coin 2. Moreover, the coin identification apparatus identifies the coin 2 based on the detection signal of the coin identification sensor 1.

This application claims priority from JP 2002-126589, filed Apr. 26, 2002, through PCT/JP03/05130, filed Apr. 22, 2003, and the disclosures of both applications are incorporated herein by reference thereto.

### BACKGROUND OF THE INVENTION

1. Technical Field

The invention relates to a coin configuration detection method and a coin identification sensor that magnetically detects the configuration of a coin to identify the kind and/or the authenticity of the coin. The invention further relates to a coin identification apparatus that identifies the kind and/or the authenticity of a coin based on the configuration detected by the coin identification sensor.

2. Description of Related Art

Various coin identification sensors that detect the surface configuration of a coin in a non-contact manner have been developed. These kinds of coin identification sensors are broadly divided into ones using optical means and ones using magnetic means.

As optical coin identification sensors, the following are known: one that photographs the coin surface by use of an optical image sensor, such as a CCD sensor, and processes the photographic data to thereby identify the surface configuration; and one that receives reflected light from the coin surface by a light receiving device, such as a photodiode, and identifies the coin surface configuration based on the light reception level. But optical coin identification sensors are not only susceptible to dirt on the coin surface but also have a drawback that they cannot detect the height and depth of the asperities.

On the other hand, as a magnetic coin identification sensor, one is known that uses the eddy current effect of a conductor in an AC magnetic field. Eddy current is generated when a conductor, such as a metal, is placed in an AC magnetic field, within the conductor so as to prevent a change in the magnetic flux passing through the conductor. Because the generation condition thereof varies according to the surface configuration of the conductor, the surface configuration can be detected by detecting a magnetic flux change due to the eddy current in the vicinity of the surface of the conductor without being affected by dirt on the conductor surface. As such a coin identification sensor, for example, one is known in which a plurality of detection coils disposed in a matrix is opposed to the coin surface and the surface configuration is detected (for example, see Japanese Published Unexamined Patent Application No. 2001-126103 and Japanese Published Unexamined Patent Application No. 2002-24894).

However, conventional magnetic coin identification sensors are limited in detection accuracy because they detect, while generating an AC magnetic field on the coil surface by an exciting coil in which the coil central line is vertical to the coin surface in the vicinity of the coin surface, the magnetic flux change in the vicinity of the coin surface by a detection coil in which the coil central line is vertical to the coin surface. That is, the detection of the surface configuration is, when the surface configuration is expressed by coordinates (X, Z) as shown in FIG. 13(A), to detect ΔZ/ΔX, and to detect this accurately, it is required that ΔX be as small as possible; however, because the detection area of a conventional coin identification sensor 100 is not less than four times the coil diameter D as shown in FIG. 13(B), the resolution in the X direction is low, so that a fine surface configuration cannot be detected.

### SUMMARY OF THE INVENTION

In view of the above-mentioned circumstances, a coin configuration detection method of the invention created for the purpose of solving these problems is a coin configuration detection method that magnetically detects the configuration of a coin to identify the kind and/or the authenticity of the coin, and is characterized in that a magnetic flux change in the vicinity of the surface of the coin is detected by a detection coil in which the coil central line is along the surface of the coin and the coil peripheral surface is locally opposed to the surface of the coin while an AC magnetic field in the direction along the surface of the coin is generated in the interior of the coin and/or in the surface space of the coin.

According to this coin configuration detection method, although an AC magnetic field along the coin surface is generated to thereby cause a magnetic change due to the surface configuration of the coin to emerge as a magnetic flux change mainly along the coin surface, the magnetic flux change is detected not by detection coils disposed vertically to the coin surface but by the detection coils disposed along the coin surface, whereby even a minute magnetic flux change whose vertical component hardly changes can be detected. Consequently, even a fine surface configuration of the coin can be detected, so that the coin configuration detection accuracy can be dramatically improved. Further, because it is easy to reduce the size of the detection coils in the direction along the coin surface, the resolution of the coin configuration detection can be easily improved by reducing the AX as much as possible.

Moreover, in view of the above-mentioned circumstances, a coin identification sensor of the invention created for the purpose of solving these problems is a coin identification sensor that magnetically detects the configuration of a coin to identify the kind and/or the authenticity of the coin, and is provided with an exciting portion that generates an AC magnetic field in the direction along the surface of the coin in the interior of the coin and/or in the surface space of the coin; and a detection coil that is disposed so that the coil central line is along the surface of the coin and the coil peripheral surface is locally opposed to the surface of the coin, and detects a magnetic flux change in the vicinity of the surface of the coin.

When the coin identification sensor is structured as described above, while an AC magnetic field along the coin surface is generated to thereby cause a magnetic change due to the surface configuration of the coin to emerge as a magnetic flux change mainly along the coin surface, the magnetic flux change is detected not by detection coils disposed vertically to the coin surface but by the detection coils disposed along the coin surface, whereby even a minute magnetic flux change whose vertical component hardly changes can be detected. Consequently, even a fine surface configuration of the coin can be detected, so that the coin configuration detection accuracy can be dramatically improved. Further, because it is easy to reduce the size of the detection coils in the direction along the coin surface, the resolution of the coin configuration detection can be easily improved by reducing the ΔX as much as possible.

Moreover, in the coin identification sensor, the exciting portion is an exciting coil disposed so that the coil inner surface or the coil peripheral surface is along the surface of the coin and generating an AC magnetic field in the direction along the surface of the coin in the interior of the coin and/or in the surface space of the coin, and the detection coil is disposed in an inner portion of the exciting coil or in the vicinity thereof, or in a peripheral portion of the exciting coil or in the vicinity thereof. In this case, not only can the detection accuracy be improved by increasing the magnetic field intensity in the vicinity of the detection coil but also the coin identification sensor can be reduced in size.

Moreover, in the coin identification sensor, the exciting portion has a plurality of coin adjacent portions, and is provided with a ferromagnetic core that forms a looped magnetic circuit with the interior of the coin and/or the surface space of the coin inside and an exciting coil that AC-excites the core and generates an AC magnetic field in the direction along the surface of the coin in the interior of the coin and/or in the surface space of the coin. In this case, because a strong magnetic field can be locally generated on the surface of the coin, the detection accuracy of the coin identification sensor can be improved.

Moreover, in the coin identification sensor, the detection coil is a differential coil capable of detecting a differential voltage, and a pair of coils constituting the differential coil line along the surface of the coin. In this case, the detection accuracy can be further improved by canceling out intrinsic errors and temperature errors of the coils.

Moreover, in the coin identification sensor, the detection coil is provided in a plurality of numbers so as to line along the surface of the coin. In this case, by scanning the coin identification sensor or the coin in a direction perpendicular to the direction in which the detection coils align, two-dimensional detection data can be obtained, and by two-dimensionally disposing a plurality of detection coils, two-dimensional detection data can be obtained without the coin identification sensor or the coin being scanned.

Moreover, in view of the above-mentioned circumstances, a coin identification apparatus of the invention created for the purpose of solving these problems is a coin identification apparatus that identifies the kind and/or the authenticity of a coin, and the configuration of the coin is detected by the above-described coin identification sensor and the kind and/or the authenticity of the coin is identified based on the detected configuration.

When the coin identification apparatus is structured as described above, because the kind and/or the authenticity of the coin is identified based on highly accurate configuration detection data by the above-described coin identification sensor, the identification accuracy of the coin identification apparatus can be dramatically improved.

### BRIEF DESCRIPTION OF THE DRAWINGS

The invention will be described with reference to the drawings in which:

FIG. 1(A) is a plan view of a coin identification sensor showing a first embodiment, FIG. 1(B) is a front view, and FIG. 1(C) is a side view;

FIG. 2(A) is a perspective view of a coin identification sensor showing the first embodiment, and FIG. 2(B) is an internal perspective view;

FIG. 3 is a working explanatory view of the coin identification sensor in the first embodiment;

FIG. 4 is an enlarged view of detection coils;

FIG. 5 is a block diagram of a detection circuit;

FIG. 6(A) is a schematic view of a coin identification sensor showing a second embodiment, and FIG. 6(B) is a schematic view showing a coin identification sensor showing a third embodiment;

FIG. 7 is a schematic view of a coin identification sensor showing a fourth embodiment;

FIGS. 8(A) to 8(F) are explanatory views showing various forms of cores in the coin identification sensor of the fourth embodiment;

FIGS. 9(A) to 9(C) are explanatory views showing various forms of exciting coils in the coin identification sensor of the fourth embodiment;

FIGS. 10(A) to 10(C) are explanatory views showing various forms of detection coils in the coin identification sensor of the fourth embodiment with FIG. 10(A) a side view, FIG. 10(B) a plan view, and FIG. 10(C) a cross sectional side view, severally showing detection coils in the coin identification sensor of the fourth embodiment;

FIGS. 11(A) to 11 (C) are explanatory views showing various forms of detection coils in the coin identification sensor of the fourth embodiment with FIG. 11(A) showing an elevational view and a side view, FIG. 11(B) an elevational view, and FIG. 11(C) a plan view, severally showing detection coils in the coin identification sensor of the fourth embodiment;

FIG. 12 is a schematic view of a coin identification sensor according to a fifth embodiment; and

FIG. 13(A) is a view showing the surface configuration as X and Y coordinates, and FIG. 13(B) is an explanatory view showing the conventional coin identification sensor.

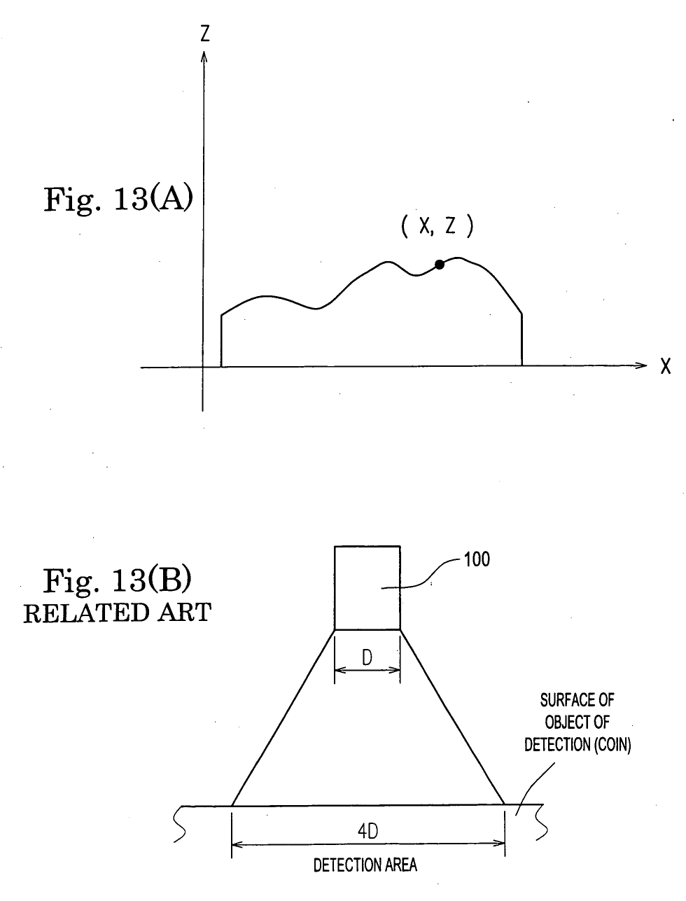

### DETAILED DESCRIPTION OF PREFERRED EMBODIMENTS

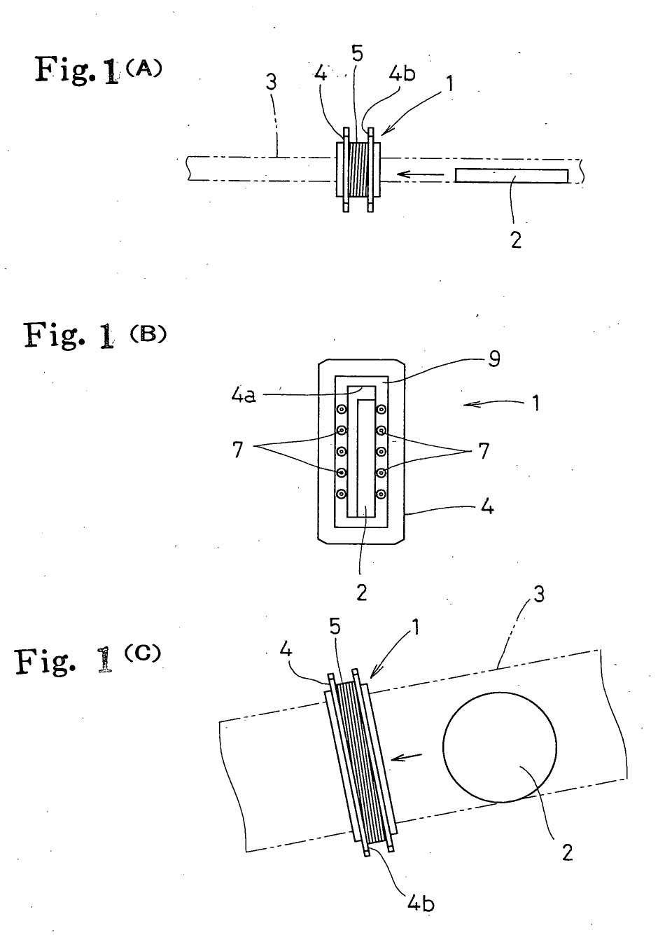

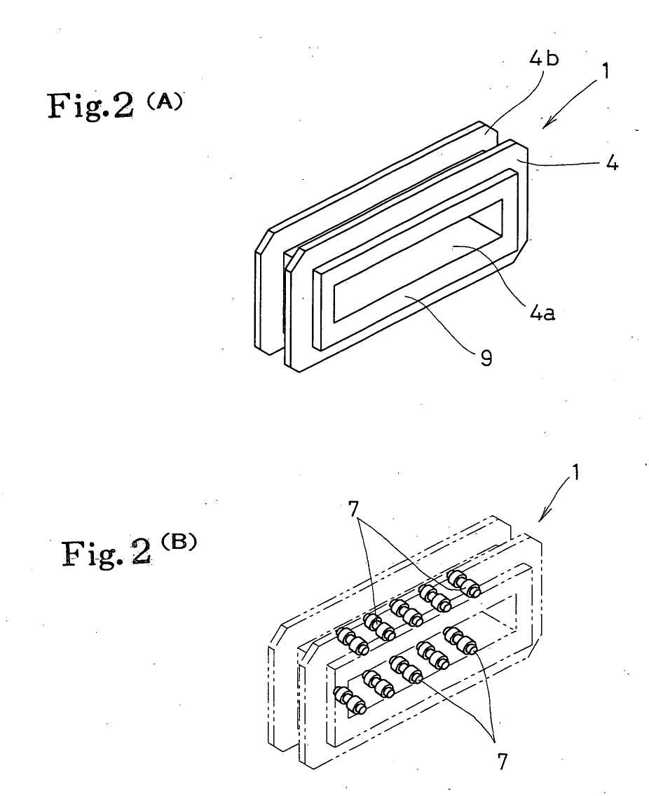

FIG. 1(A) is a plan view of a coin identification sensor showing a first exemplary embodiment, FIG. 1(B) is a front view, FIG. 1(C) is a side view, FIG. 2(A) is a perspective view of the coin identification sensor showing the first embodiment, and FIG. 2(B) is an internal perspective view. The coin identification sensor 1 shown in these figures is disposed on a coin passage 3 where a coin 2 passes, and magnetically detects the surface configuration of the coin 2 passing along the coin passage 3.

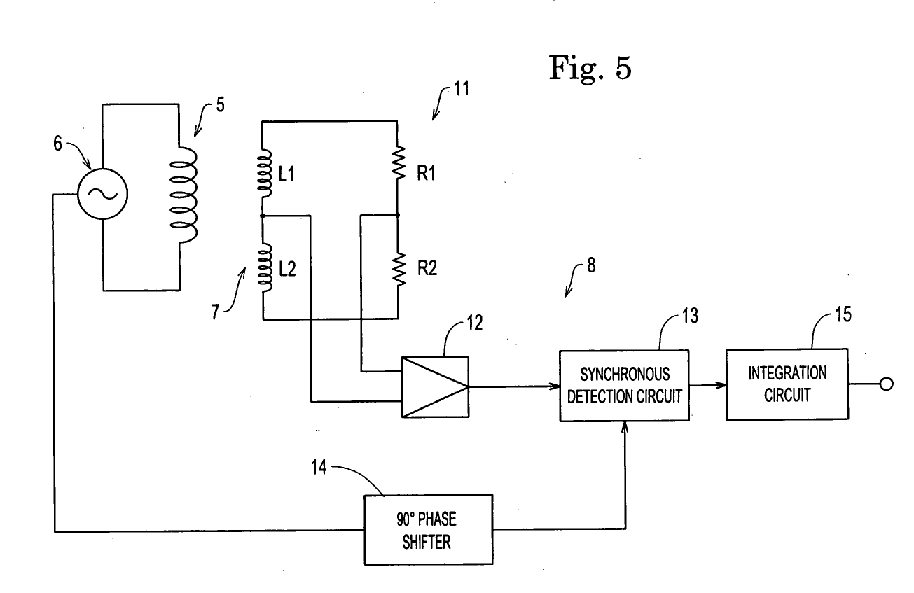

The coin identification sensor 1 of the first embodiment is provided with an exciting coil (exciting portion) 5 that is wound around the periphery of a coil bobbin 4; an AC exciting circuit portion 6 (FIG. 5) that AC-excites the exciting coil 5; a plurality of detection coils 7 disposed on the inner surface of the coil bobbin 4; and a detection circuit portion 8 that takes out the detection signals of the detection coils 7. The coil bobbin 4 is, for example, a rectangular-tube-form resin mold. On the inner portion thereof, a coin passage 4a through which the coin 2 can pass is formed, and on the periphery thereof, a coil winding groove 4b for winding the exciting coil 5 is formed.

The exciting coil 5 is AC-excited at a predetermined frequency by the AC exciting circuit portion 6 to generate an AC magnetic field. The AC magnetic field is generated in the direction along the surface of the coin 2 situated in the coin passage 4a, and causes a magnetic change due to the coin surface configuration to emerge as a magnetic flux change of a parallel component mainly along the coin surface. The detection coils 7 are disposed so that the coil central lines are along the coin surface and the coil peripheral surfaces are locally opposed to the coin surface. When the coin 2 is situated in the coin passage 4a, the detection coils 7 detect a magnetic flux change along the surface of the coin 2 in the vicinity of the surface of the coin 2.

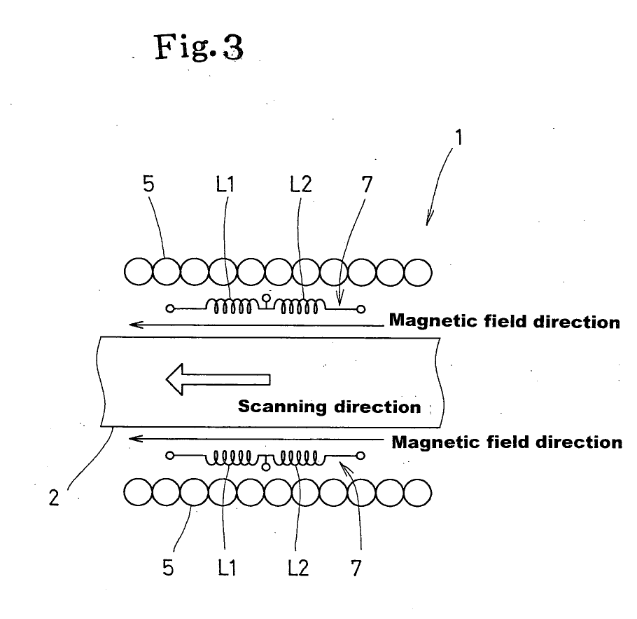

That is, as shown in FIG. 3, the coin identification sensor 1 detects, while generating an AC magnetic field along the surface of the coin 2 to thereby cause a magnetic change due to the surface configuration of the coin 2 to emerge as a magnetic flux change mainly along the surface of the coin 2, the magnetic flux change is detected, not by detection coils disposed vertically to the surface of the coin 2, rather by the detection coils 7 disposed along the surface of the coin 2, whereby even a minute magnetic flux change whose vertical component hardly changes can be detected. Consequently, even a fine surface configuration of the coin 2 can be detected, so that the coin configuration detection accuracy can be dramatically improved.

Moreover, in the thus structured coin identification sensor 1, the resolution in the ΔX direction can be determined based on the size of the detection coils 7 in the direction of the coil central lines. Further, because the above-mentioned size is easily reduced by using spiral coils or multilayer coils as the detection coils 7, the resolution of the coin configuration detection can be easily improved by reducing the ΔX as much as possible. Moreover, because the detection coils 7 are disposed on the inner surface of the exciting coil 5, while a strong magnetic field is generated in the vicinity of the detection coils 7, the magnetic flux change can be accurately detected by the detection coils 7. In the figures, reference numeral 9 represents a molded resin in which the detection coils 7 are held in a buried condition.

Moreover, in the coin identification sensor 1, a plurality of detection coils 7 is disposed at predetermined intervals in the circumferential direction on the inner surface of the coil bobbin 4. By this, not only can the surface configuration of the coin 2 be detected by the plurality of detection coils 7 while the exciting coil 5 is also used but also the surface configuration of the coin 2 can be two-dimensionally scanned by moving the coin identification sensor 1 and the coin 2 relative to one another. Further, according to the first embodiment, because the plurality of detection coils 7 is disposed in opposing positions on the inner surface of the coil bobbin 4, the obverse side surface configuration and the reverse side surface configuration of the coin 2 can be detected at the same time.

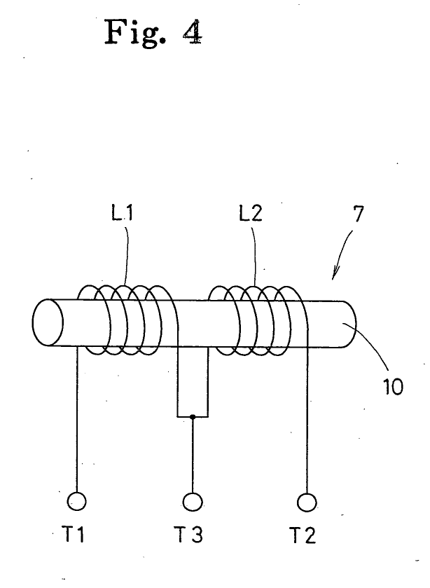

FIG. 4 is an enlarged view of the detection coils, and FIG. 5 is a block diagram of the detection circuit. As shown in these figures, the detection coils 7 of the present embodiment are formed by winding (for example, a width of 1.0 mm) a pair of detection coils L1, L2 disposed in a line along the surface of the coin 2 on a cylindrical core material 10 having a diameter of, for example, 0.5 mm. The detection coils L1, L2 are connected in series, and a center tap terminal T3 derived between the detection coils L1, L2 is provided as well as terminals T1, T2 derived from both ends of the detection coils L1, L2.

As shown in FIG. 5, the detection coils L1, L2 constitute a bridge circuit 11 together with a pair of resistors R1, R2 (or variable resistors), and the differential voltage of the detection coils L1, L2 is outputted from the bridge circuit 11. In the bridge circuit 11, the resistance values of the resistors R1, R2 are initially adjusted so that the differential output is a predetermined value when the coin 2 is absent in the coin passage 4a. By this, not only can a detection signal in which intrinsic errors and temperature errors of the detection coils L1, L2 are canceled out be obtained but also the resolution in the ΔX direction can be improved.

The differential output of the bridge circuit 11 is amplified by a differential amplifier circuit 12 and is then inputted to a synchronous detection circuit 13. The synchronous detection circuit 13 receives a synchronization signal from the AC exciting circuit portion 6 through a 90° phase shifter 14, and detects the differential output in the cycle thereof to obtain a magnetic flux change signal. The magnetic flux change signal passes through an integration circuit 15 and is then outputted as a surface configuration detection signal from the coin identification sensor 1. In this connection, the output signal of the coin identification sensor 1 is inputted to a higher controller and used for the identification of the coin 2 in the controller.

In the apparatus structured as described above, the coin identification sensor 1 detects, while generating an AC magnetic field along the surface of the coin 2 to thereby cause a magnetic change due to the surface configuration of the coin 2 to emerge as a magnetic flux change of a parallel component mainly along the surface of the coin 2, the magnetic flux change, not by detection coils disposed vertically to the surface of the coin 2, rather by the detection coils 7 disposed along the surface of the coin 2, whereby even a minute magnetic flux change whose vertical component hardly changes can be detected. By this, even a fine surface configuration of the coin 2 can be detected, so that the coin configuration detection accuracy can be dramatically improved. Further, because it is easy to reduce the size of the detection coils 7 in the direction along the coin surface, the resolution of the coin configuration detection can be easily improved by reducing the AX as much as possible.

Moreover, because the exciting coil 5 is disposed so that the coil inner surface is along the surface of the coin 2 and generates an AC magnetic field in the direction along the surface of the coin 2 in the interior and the surface space of the coin 2 and the detection coils 7 are disposed in the inner surface portion (including in the vicinity thereof) of the exciting coil 5, not only can the detection accuracy be improved by increasing the magnetic field intensity in the vicinity of the detection coils 7 but also the coin identification sensor 1 can be reduced in size.

Moreover, because the detection coils 7 are differential coils capable of detecting a differential voltage and the pair of coils L1, L2 constituting the differential coils are disposed along the surface of the coin 2, the detection accuracy can be further improved by canceling out intrinsic errors and temperature errors of the coils L1, L2.

Moreover, because more than one detection coil 7 is provided so as to lie along the surface of the coin 2, by scanning (moving) the coin identification sensor 1 or the coin 2 in a direction perpendicular to the direction in which the detection coils 7 align, two-dimensional detection data can be obtained, and by two-dimensionally disposing a plurality of detection coils 7, two-dimensional detection data can be obtained without the coin identification sensor 1 or the coin 2 being scanned (moved).

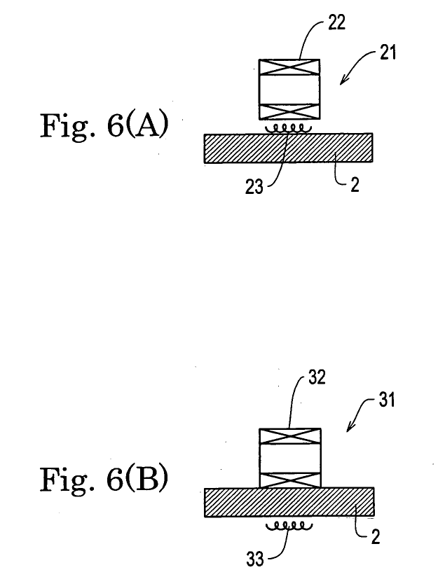

FIG. 6(A) is a schematic view of a coin identification sensor showing a second embodiment, and FIG. 6(B) is a schematic view of a coin identification sensor showing a third embodiment. As shown in the figures, the coin identification sensor 21 of the second embodiment is provided with an exciting coil 22 disposed so that the coil peripheral surface is along the surface of the coin 2; and a detection coil 23 disposed on the periphery thereof (including in the vicinity thereof). The coin identification sensor 31 of the third embodiment comprises an exciting coil 32 and a detection coil 33 disposed so as to sandwich the coin 2. The thus structured coin identification sensors 21, 31 produce substantially similar effects to those of the first embodiment.

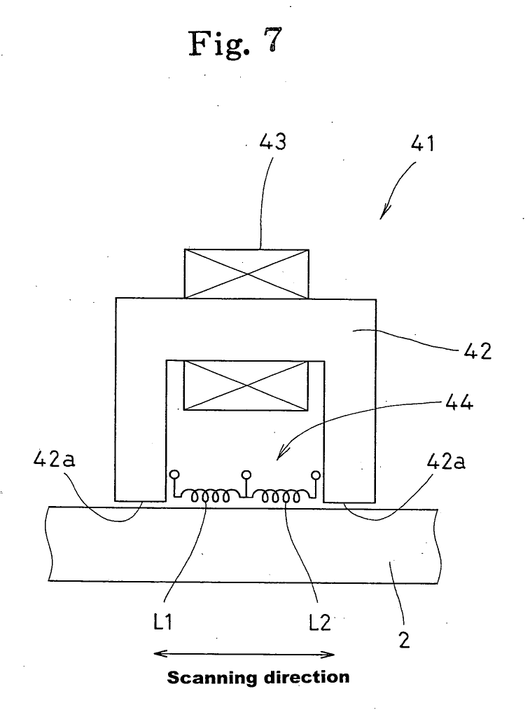

FIG. 7 is a schematic view of a coin identification sensor showing a fourth embodiment. As shown in this figure, the coin identification sensor 41 of the fourth embodiment is provided with a core 42, an exciting coil 43 and a detection coil 44. The core 42 has a plurality of coin adjacent portions 42a, and is made of a ferromagnetic material so as to form a looped magnetic circuit with the interior and the surface space of the coin 2 inside.

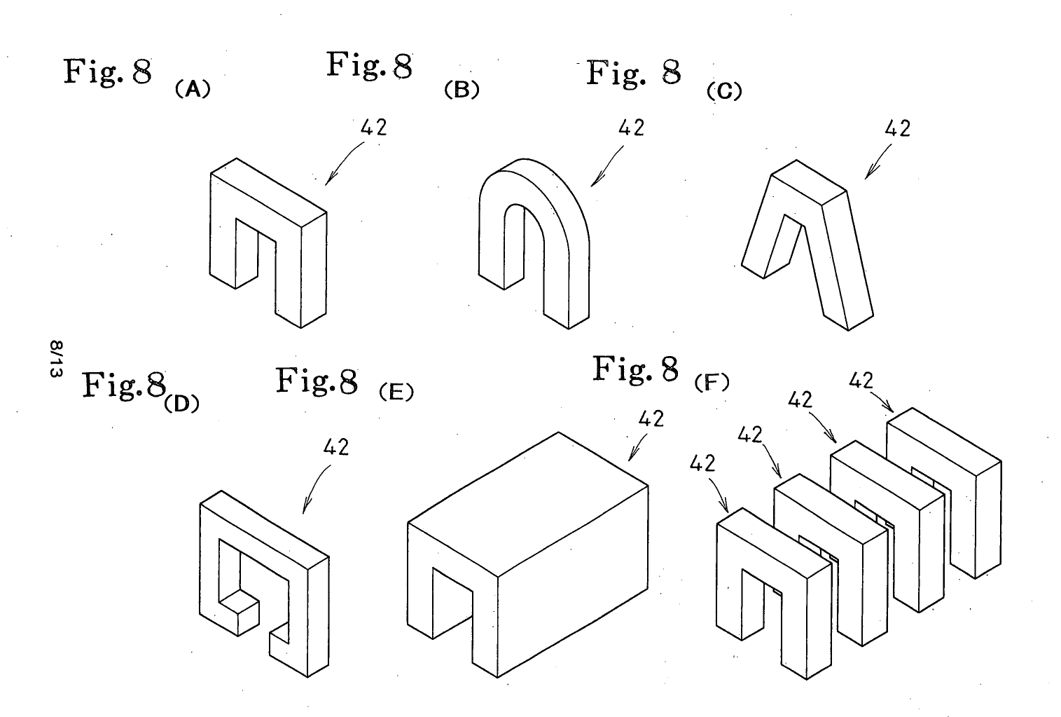

FIG. 8 is an explanatory view showing various forms of cores in the coin identification sensor of the fourth embodiment. Cores 42 shown in this figure are all ferromagnetic members capable of forming a magnetic circuit, and formed using, for example, ferrite. As the shape of the core 42, the following are adoptable: an angular or block U-shape as shown in FIG. 8(A); a U-shape as shown in FIG. 8(B); a V-shape as shown in FIG. 8(C); and a C-shape as shown in FIG. 8(D). Moreover, the dimensions of the core 42 are set in accordance with the excitation range and, for example, when the core 42 is wide in the direction in which the exciting coil 43 is wound as shown in FIG. 8(E), the detection area can be increased by one-dimensionally disposing a multiplicity of detection coils 44 on the inner surface portion of the core 42. Moreover, equal effects are obtained by juxtaposing a plurality of cores 42 as shown in FIG. 8(F).

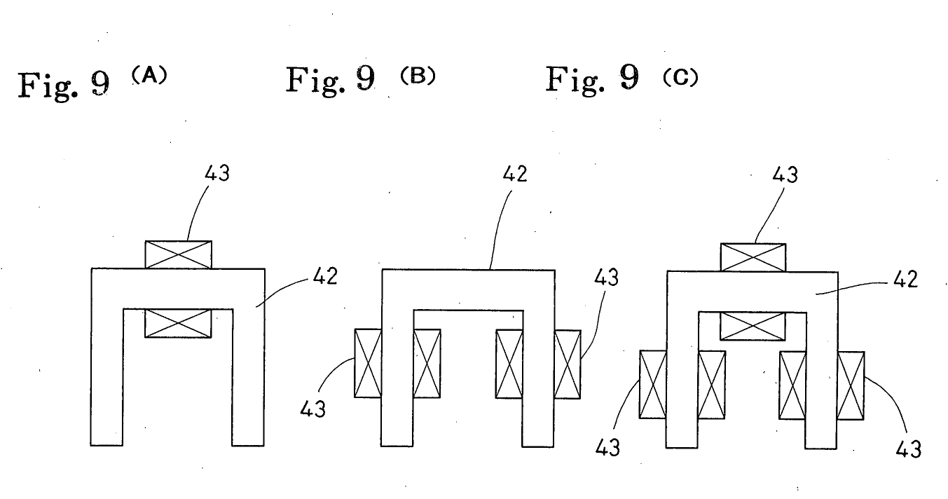

The exciting coil 43 is wound around the core 42, and an AC voltage of a predetermined frequency is applied thereto. When the AC voltage is applied to the exciting coil 43, the core 42 is AC-excited, so that an AC magnetic field along the surface of the coin 2 is generated in the interior and the surface space of the coin 2. The position of winding of the exciting coil 43 around the core 42 is not limited to an upper part of the core 42 as shown in FIG. 9(A), but may be right and left leg portions of the core 42 as shown in FIG. 9(B). Moreover, the exciting coil 43 may be wound around an upper part and right and left leg portions of the core 42 as shown in FIG. 9(C).

The detection coils 44 are disposed so that the coil central lines are along the surface of the coin 2 and the coil peripheral surface are locally opposed to the surface of the coin 2, and detect a magnetic flux change in the vicinity of the surface of the coin 2. That is, the coin identification sensor 41 of the fourth embodiment is structured so as to detect a local magnetic flux change in the vicinity of the coin 2 while forming a looped magnetic circuit by the exciting coil 43 and the core 42. Consequently, while a strong magnetic field is locally generated on the surface of the coin 2, the magnetic flux change can be accurately detected by the detection coils 44.

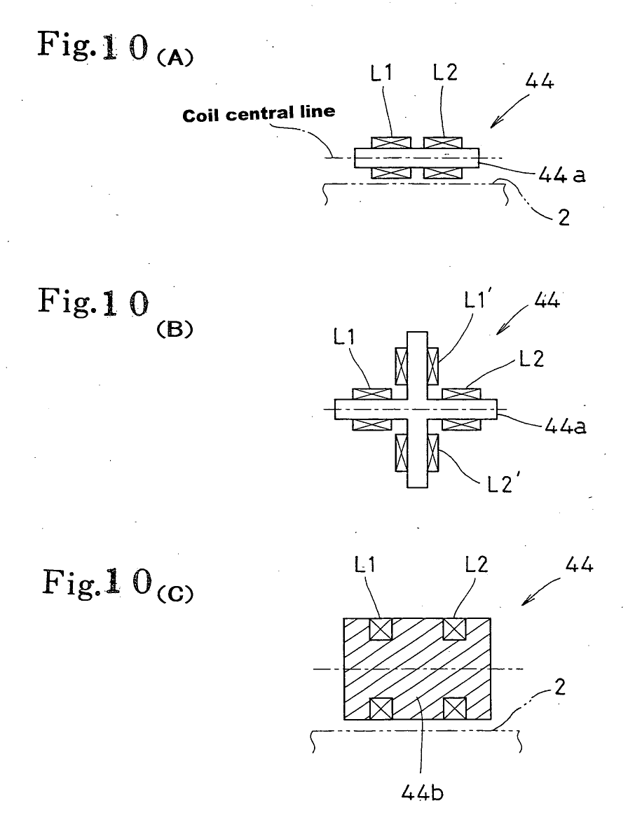

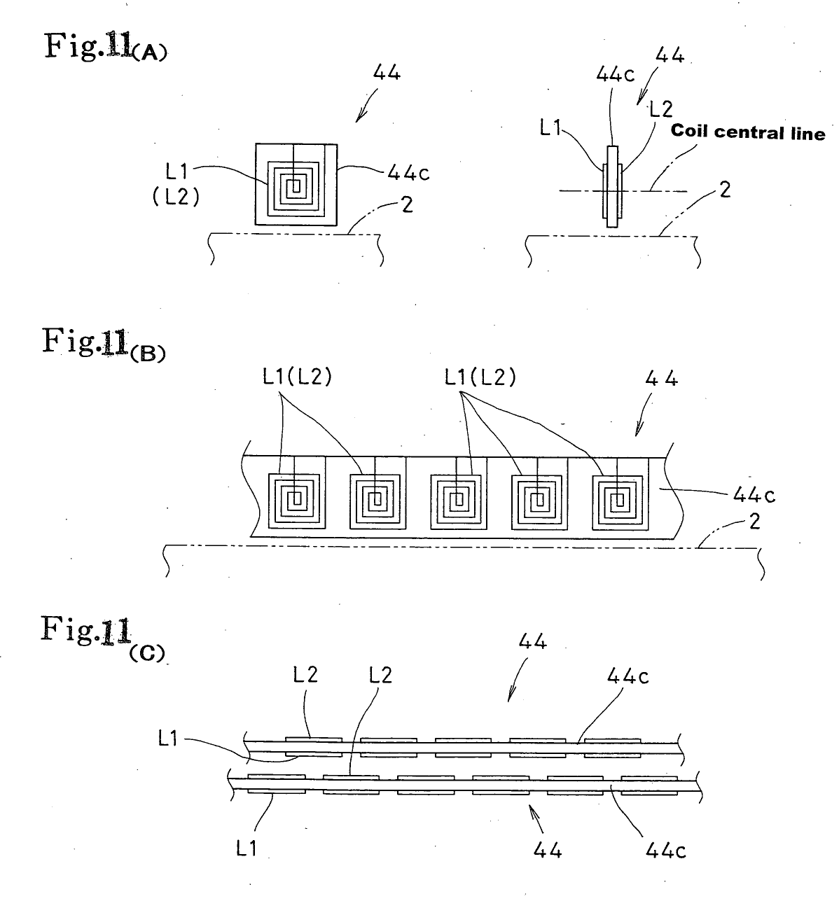

FIGS. 10(A)-10(C) and 11(A)-11(C) are explanatory views showing various forms of detection coils in the coin identification sensor of the fourth embodiment. The detection coils 44 shown in these figures are all air core coils. For example, in the detection coil 44 of FIG. 10(A) (equal to the one of FIG. 2), coils L1, L2 are formed by winding a lead wire to which an insulating coating is applied, around a non-magnetic core material 44a. Moreover, the one shown in FIG. 10(B) is a biaxial type in which a pair of detection coils 44 are integrated in an intersecting condition, and these detection coils 44 are all disposed along the surface of the coin 2.

FIG. 10(C) shows a detection coil 44 formed so that the thickness in the direction of the coil central line is as small as possible. On the periphery of a former (bobbin) 44b used for the detection coil 44, two coil winding grooves with a predetermined width (for example, 50 μm) are formed at a predetermined interval (for example, 50 μm), and the detection coil 44 is formed by winding in layers a lead wire to which an insulating coating is applied, along each coil winding groove. In the thus structured detection coil 44, because the thickness in the direction of the coil central line is small and the distance between the coils L1, L2 is short, the resolution in the direction of the coil central line can be significantly improved.

The detection coil 44 shown in FIGS. 11(A)-11(C) is formed as a thin-film circuit pattern (spiral coil) on a base material 44c made of an insulating material. For example, a base material 44c for a thin-film substrate (for example, a ceramic substrate) is used, and a conductor layer (for example, a copper foil) formed on the obverse and reverse surfaces thereof is evaporated based on the circuit pattern to thereby form the thin-film coils L1, L2. According to this detection coil 44, because the pair of coils L1, L2, constituting a differential coil, are formed in layers with the extremely thin base material 44c in between, the resolution in the direction of the coil central line can be dramatically improved.

In the detection coil 44 structured as described above, it is easy to one-dimensionally dispose the coils L1, L2 as shown in FIG. 11(B). When a plurality of coils L1, L2 are one-dimensionally disposed like this, by scanning (moving) the coin identification sensor 41 or the coin 2 in a direction perpendicular to the direction in which the coils L1, L2 are disposed, two-dimensional detection data can be obtained. Moreover, detection coils 44 in which a plurality of coils L1, L2 are one-dimensionally disposed may be juxtaposed in the direction of scanning of the coin identification sensor 41 or the coin 2 as shown in FIG. 11(C). In this case, by disposing the coils L1, L2 formed in the front and rear detection coils 44 so as to be shifted by half a pitch from each other, the gap in the direction of one-dimensional disposition is eliminated, and the coin configuration can be detected without omission. A plurality of detection coils 44 may be two-dimensionally disposed, and in this case, two-dimensional detection data is obtained without the scanning of the coin identification sensor 41 or the coin 2. The detection coils 44 shown in FIGS. 10(A)-10(C) and 11(A)-11(C) are applicable to other embodiments.

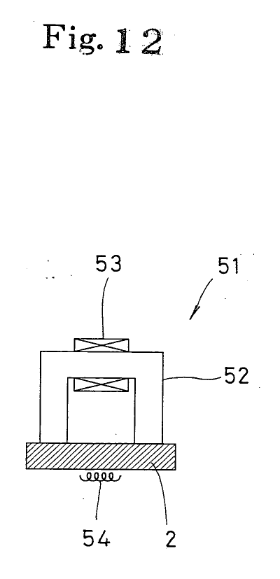

FIG. 12 is a schematic view of a coin identification sensor showing a fifth embodiment. As shown in the figure, in the coin identification sensor 51 of the fifth embodiment, an exciting coil 53 (core 52) and a detection coil 54 are disposed so as to sandwich the coin 2. The coin identification sensor 51 structured as described above produces similar effects as those of the fourth embodiment.

Next, an exemplary coin configuration detection method according to the invention will be described. In the coin configuration detection method of the invention, to identify the kind and/or the authenticity of a coin, the coin configuration is magnetically detected, and while an AC magnetic field in the direction along the surface of the coin is generated in the interior of the coin and/or in the surface space of the coin, a magnetic flux change in the vicinity of the coin surface is detected by a detection coil in which the coil central line is along the coin surface and the coil peripheral surface is locally opposed to the coin surface. Specifically, by using any of the above-described coin identification sensors (1, 21, 31, 41, 51), the coin configuration detection method of the invention can be implemented.

When the coin configuration detection method is used, while an AC magnetic field along the coin surface is generated to thereby cause a magnetic change due to the surface configuration of the coin to emerge as a magnetic flux change mainly along the coin surface, the magnetic flux change, is detected not by detection coils disposed vertically to the coin surface but by the detection coils disposed along the coin surface, whereby even a minute magnetic flux change whose vertical component hardly changes can be detected. By this, even a fine surface configuration of the coin can be detected, so that the coin configuration detection accuracy can be dramatically improved. Further, because it is easy to reduce the size of the detection coils in the direction along the coin surface, the resolution of the coin configuration detection can be easily improved by reducing the AX as much as possible.

Next, an exemplary coin identification apparatus according to the invention will be described. The coin identification apparatus of the invention identifies the kind and/or the authenticity of a coin, and is structured so as to detect the coin configuration by the coin identification sensor according to the invention (specifically, the coin identification sensor 1, 21, 31, 41 or 51 of the above-described embodiment) and identify the kind and/or the authenticity of the coin based on the detected configuration.

As a concrete structure of the coin identification apparatus, for example, the following are provided: a filter that receives detection data from the coin identification sensor and removes the noise thereof; a binarization processor that binarizes the detection data by use of a predetermined threshold value; a recognition area identifier that identifies a recognition area in the binarized data; a matching processor that matches the binarized data in the recognition area with prestored coin configuration patterns; and a determination processor that determines the kind and/or the authenticity of the coin based on the hit rate (correlation function). These processings can be realized not only by hardware processing using a dedicated IC or the like but also by program processing using a microcomputer or the like.

Thus, the invention relates to a coin configuration detection method and a coin identification sensor that magnetically detects the coin configuration to identify the kind and/or the authenticity of the coin or to a coin identification apparatus that identifies the kind and/or the authenticity of the coin based on the configuration detected by the coin identification sensor. The invention is usable as the coin identifier of vending machines and automatic ticket vending machines, and is particularly useful as a coin identification apparatus for financial institutions requiring high coin identification accuracy.

1. A coin configuration detection method that magnetically detects a configuration of a coin to identify a kind and/or authenticity of the coin, comprising:
detecting a magnetic flux change in a vicinity of a surface of the coin using a detection coil in which a coil central line extends along the surface of the coin and a coil peripheral surface is locally opposed to the surface of the coin while an AC magnetic field along the surface of the coin is generated in an interior of and/or in a surface space of the coin.

2. A coin identification sensor that magnetically detects a configuration of a coin to identify a kind and/or authenticity of the coin, comprising:
an exciting portion that generates an AC magnetic field along a surface of the coin in an interior of and/or in a surface space of the coin; and
a detection coil is disposed so that a coil central line extends along the surface of the coin and a coil peripheral surface is locally opposed to the surface of the coin, the detection coil detects a magnetic flux change in a vicinity of the surface of the coin.

3. The coin identification sensor according to claim 2, wherein the exciting portion is an exciting coil disposed so that a coil inner peripheral surface or a coil peripheral surface is along the surface of the coin and which generates an AC magnetic field in the direction along the surface of the coin in the interior and/or in the surface space of the coin, and the detection coil is disposed in or in a vicinity of an inner peripheral portion of the exciting coil or disposed in or in a vicinity of a peripheral portion of the exciting coil.

4. The coin identification sensor according to claim 2, wherein the exciting portion has a plurality of coin adjacent portions, and is provided with a ferromagnetic core that forms a looped magnetic circuit with the interior and the surface space of the coin inside and an exciting coil that AC-excites the core and generates an AC magnetic field in the direction along the surface in the interior of the coin and/or in the surface space of the coin.

5. The coin identification sensor according to claim 2, wherein the detection coil is a differential coil capable of detecting a differential voltage, and a pair of coils constitute a differential coil line along the surface of the coin.

6. The coin identification sensor according to any of claim 2, wherein a plurality of detection coils are provided to line along the surface of the coin.

7. A coin identification apparatus that identifies a kind and/or authenticity of a coin, wherein a configuration of the coin is detected by the coin identification sensor according to claim 2 and the kind and/or the authenticity of the coin is identified based on a detected configuration.

8. The coin identification sensor according to claim 3, wherein the detection coil is a differential coil capable of detecting a differential voltage, and a pair of coils constitute a differential coil line along the surface of the coin.

9. The coin identification sensor according to claim 4, wherein the detection coil is a differential coil capable of detecting a differential voltage, and a pair of coils constitute a differential coil line along the surface of the coin.

10. The coin identification sensor according to claim 3, wherein a plurality of detection coils are provided to line along the surface of the coin.

11. The coin identification sensor according to claim 4, wherein a plurality of detection coils are provided to line along the surface of the coin.

12. The coin identification sensor according to claim 5, wherein a plurality of detection coils are provided to line along the surface of the coin.

13. The coin identification sensor according to claim 8, wherein a plurality of detection coils are provided to line along the surface of the coin.

14. The coin identification sensor according to claim 9, wherein a plurality of detection coils are provided to line along the surface of the coin.

15. A coin identification apparatus that identifies a kind and/or authenticity of a coin, wherein a configuration of the coin is detected by the coin identification sensor according to claim 3 and the kind and/or the authenticity of the coin is identified based on a detected configuration.

16. A coin identification apparatus that identifies a kind and/or authenticity of a coin, wherein a configuration of the coin is detected by the coin identification sensor according to claim 4 and the kind and/or the authenticity of the coin is identified based on a detected configuration.

17. A coin identification apparatus that identifies a kind and/or authenticity of a coin, wherein a configuration of the coin is detected by the coin identification sensor according to claim 5 and the kind and/or the authenticity of the coin is identified based on a detected configuration.

18. A coin identification apparatus that identifies a kind and/or authenticity of a coin, wherein a configuration of the coin is detected by the coin identification sensor according to claim 6 and the kind and/or the authenticity of the coin is identified based on a detected configuration.

19. A coin identification apparatus that identifies a kind and/or authenticity of a coin, wherein a configuration of the coin is detected by the coin identification sensor according to claim 13 and the kind and/or the authenticity of the coin is identified based on a detected configuration.

20. A coin identification apparatus that identifies a kind and/or authenticity of a coin, wherein a configuration of the coin is detected by the coin identification sensor according to claim 14 and the kind and/or the authenticity of the coin is identified based on a detected configuration.
